(19) United States
(12) Patent Application Publication
(10) Pub. No.: US 2008/0287633 A1
(43) Pub. Date: Nov. 20, 2008

(54) Hydrogel Materials

(76) Inventor: Paul D. Drumheller, Flagstaff, AZ (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/750,673

(22) Filed: May 18, 2007

(51) Int. Cl. C08F 210/02

(52) U.S. Cl. 526/348

(57) ABSTRACT

The present invention relates to biocompatible crosslinked biomaterials made from polycondensation polymerization reactions involving polynucleophilic-polyelectrophilic precursors that address the limitations of steric hindrance, viscosity, and diffusion currently reducing gelation rates and curing thoroughness of the biomaterials. A cross-linking scheme is utilized in the invention that permits rapid gelation and thorough curing of the biomaterial. The biomaterial is made by polycondensation polymerization of polynucleophilic-polyelectrophilic precursors to form a water-soluble polymer crosslinked with a water-soluble crosslinker having at most one core cyclic structure.

### BACKGROUND OF THE INVENTION

Biocompatible crosslinked biomaterials made with crosslinked water soluble polymers are recognized as providing therapeutic options for the treatment of disease and injury. Historically, diseases and injuries have often been treated with systemic administration of drugs. However, it has recently been appreciated that biocompatible crosslinked biomaterials can be used as depots for release of drugs to local targeted sites within the body. Locally administered drugs can obviate the need for systemic administration of drugs. In many instances, systemically administered drugs are given at high concentrations in order to deliver an effective amount of the drug at a local organ, tissue, or cell site. High concentrations of some drugs can elicit undesirable side effects.

It has also been appreciated that the performance, longevity, or biocompatibility of medical devices may be improved when combined with biocompatible crosslinked biomaterials. Such devices have utility in the treatment of disease, injury, repair of congenital defects, or reconstruction of a tissue or organ.

In yet other applications, it has been appreciated that medical devices made solely of biocompatible crosslinked biomaterials have utility in various surgical or interventional procedures. For example, biocompatible crosslinked biomaterials have been used as embolic agents to reduce blood flow in a variety of medical procedures, including treatment of uterine fibroid tumors, treatment of arteriovenous malformations and fistulae, filling and sealing aneurysmal sac endoleaks, occluding tubular vessels, and sealing of punctures. In addition to hemostatic agents and sealants, biocompatible crosslinked biomaterials can be used to coat organs, form implantable articles, and deliver drugs.

Biocompatible crosslinked biomaterials are usually provided in a pre-formed configuration or acquire a form when delivered to a desired site. Biocompatible crosslinked biomaterials that cure or gel directly at the implant site (i.e., in situ) are often preferred in surgical or interventional procedures. Prior to gelling, in situ gelling biomaterials are in a liquid state during transportation to a delivery site. At the delivery site, liquefied gelling precursors are expressed from a delivery apparatus and flowed into or onto a target organ, tissue, or medical device. The applied liquefied gelling precursors then polymerize to form a cross-linked, three-dimensional, biomaterial. Such polymerization may be ionic or covalent in nature. One such covalent polymerization is the polycondensation polymerization of a polyelectrophilic water-soluble biocompatible polymer with a polynucleophilic crosslinker. In this reaction scheme, the polymer contains at least two functional groups, the crosslinker contains at least two functional groups, and the total number of functional groups is at least five.

Many biocompatible crosslinked biomaterials are prepared via covalent polycondensation crosslinking. In polycondensation crosslinking, a biocompatible polymer is modified to introduce multiple electrophilic groups along its polymer backbone. These electrophilic groups are highly reactive to nucleophilic species. When the modified polyelectrophilic polymer is reacted with a polynucleophilic crosslinker, a cross-linked, three dimensional, biomaterial is produced. In other cases, a biocompatible polymer is modified to introduce multiple nucleophilic groups along its polymer backbone. These nucleophilic groups are highly reactive to electrophilic species. When the modified polynucleophilic polymer is reacted with a polyelectrophilic crosslinker, a crosslinked, three-dimensional, biomaterial is produced. In all cases, the water-soluble biocompatible polymer contains at least two functional groups, the crosslinker contains at least two functional groups, and the total number of functional groups is at least five.

U.S. Pat. No. 5,514,379, issued to Weissleder et al., discloses a crosslinked biomaterial composition prepared using a polymeric backbone crosslinked to a crosslinking agent. The polymeric backbone is said to be composed of proteins, polysaccharides, polypeptides, or polynucleophilic polyethylene glycol. The polymeric backbone is crosslinked with a polyelectrophilic polyethylene glycol crosslinking agent. The backbone comprises non-synthetic polymers of polypeptides or polysaccharides, including aminated polysaccharides and glycosaminoglycans all of which are linear macromolecular polymers made of repeating saccharide moieties having molecular weights ranging from about 20,000 Daltons to beyond 500,000 Daltons. In these materials, both the backbone and the crosslinking agent are synthetic polymers having either a linear or branched structure.

U.S. Pat. No. 5,583,114, issued to Barrows et al., discloses a crosslinked biomaterial composition prepared from a hydrophilic polyfunctional polymer. The polyfunctional polymers are linear or branched in structure. The crosslinked biomaterial is made with a polyelectrophilic polyethylene glycol polymer covalently crosslinked via polycondensation with a globular protein having a linear polypeptide backbone in the form of serum albumin.

U.S. Pat. No. 5,874,500, issued to Rhee et al., discloses a crosslinked biomaterial composition prepared using polyalkylene oxide polymers. These polymers are linear or branched in structure. The crosslinked biomaterial comprises a polynucleophilic polyethylene glycol polymer covalently crosslinked via polycondensation with a polyelectrophilic polyethylene glycol polymer.

U.S. Pat. No. 6,458,147, issued to Cruise et al., discloses a crosslinked biomaterial composition prepared using a hydrophilic polyfunctional polymer. These polymers are linear or branched in structure. The crosslinked biomaterial comprises a polyelectrophilic polyethylene glycol polymer covalently crosslinked via polycondensation with a globular protein having a linear polypeptide backbone in the form of recombinant human serum albumin.

U.S. Pat. No. 6,566,406, issued to Pathak et al., discloses a crosslinked biomaterial composition prepared using synthetic biocompatible polyfunctional polymers. These polymers are linear or branched in structure. The crosslinker is also linear or branched in structure. The crosslinked biomaterial comprises a polyelectrophilic polyethylene glycol polymer covalently crosslinked via polycondensation with a low molecular weight polynucleophilic branched crosslinker.

U.S. Patent Application 2002/0042473, discloses crosslinkable compositions prepared from at least three biocompatible components having reactive functional groups with at least one component comprising a polyfunctional hydrophilic polymer. The first component is polynucleophilic, the second component is polyelectrophilic, and the third component is reactive with either the first or second component. All components are either linear or branched in structure.

While useful for preparing biocompatible crosslinked biomaterials, the in situ gelling of a biocompatible biopolymer via the polycondensation polymerization of polynucleophilic-polyelectrophilic precursors has limitations. First, diffusion of precursors during the in situ gelling process can be hampered if the starting materials have a sufficiently high molecular weight to reduce the extent of cure and the kinetics of gelation. Second, the viscosity of the precursor solution can be high and continue to rise rapidly during the in situ gelling process, thereby reducing the extent of cure and negatively influencing the dynamics of gelation. Third, steric hindrance can occur in these systems when the precursors having functional species in close proximity sterically hinder one another and limit polycondensation reactions during the in situ gelling process.

The prior art has taught strategies to address the first two limitations of diffusion and viscosity encountered during the in situ gelling of a biocompatible biopolymer via the polycondensation polymerization of polynucleophilic-polyelectrophilic precursors. First, the use of low molecular weight crosslinkers permits diffusion of the crosslinkers throughout a volume of precursor material during the in situ gelling process and permits faster crosslinking of the precursor material and a more thorough cure of the biomaterial. Second, the use of crosslinkers comprising a branched or “comb-shaped” or “star-shaped” structure, rather than a linear structure, reduces the inherent viscosity of a crosslinker solution and permits improved mixing and a more thorough cure of the biomaterial during the in situ gelling process. However, these two strategies do not address the third limitation of steric hindrance on gelation rates and the thoroughness of curing. Steric hindrance of polycondensation reactions reduces the extent of cure and the kinetics of gelation. The prior art does not address how steric hindrance limitations may be overcome for the in situ gelling of a biocompatible biomaterial via polycondensation polymerization. Low molecular weight precursors, though they may improve diffusion limitations, may suffer from steric hindrance when the precursors have functional species in close proximity to one another. Branched or comb-shaped or star-shaped crosslinking compositions may also suffer from steric hindrance if the “arms” of the branched or comb-shaped or star-shaped compound are mobile and can orient to interfere with the ability of functional groups of the crosslinker to react.

There is a need, therefore, for biocompatible crosslinked biomaterials made from polycondensation polymerization reactions involving in situ gelling of polynucleophilic-polyelectrophilic precursors that address all three limitations currently reducing gelation rates and curing thoroughness of the biomaterials.

### SUMMARY OF THE INVENTION

The present invention relates to materials and methods addressing the above-summarized viscosity, diffusion, and steric hindrance restrictions currently limiting gelation rates and curing thoroughness of hydrogel materials. Materials of the present invention are made by way of polycondensation polymerization reactions involving polynucleophilic-polyelectrophilic precursors using a cross-linking compound that permits rapid gelation and thorough curing of the hydrogel material. The cross-linking compound has a cyclic configuration and is water soluble. Hydrogel materials of the present invention, therefore, are made via polycondensation polymerization of polynucleophilic-polyelectrophilic precursors to form a water-soluble polymer crosslinked with a water-soluble cyclic crosslinker. Hydrogel materials of the present invention can be formed in situ.

Cyclic crosslinkers of the present invention are organic compounds with a core ring structure and two or more reactive species attached directly or indirectly to the core ring. In the present invention, cyclic crosslinkers are water soluble. Cyclic crosslinkers in the present invention permit rapid gelation and thorough curing of a hydrogel material.

One embodiment of the present invention relates to a hydrogel material comprising at least one water-soluble polymer cross-linked with a water-soluble crosslinker, wherein the crosslinker is an organic molecule with one core cyclic structure, two or more linking groups attached to the core cyclic structure, and one or more functional groups attached to each linking group. The water-soluble polymer can be synthetic.

Another embodiment of the present invention relates to a method of making a hydrogel material comprising providing at least one water-soluble polymer, providing a crosslinker in the form of an organic molecule with a molecular weight less than about 10,000 Daltons, wherein said organic molecule has one core cyclic structure, two or more linking groups attached to the core cyclic structure, and one or more functional groups attached to each linking group, and admixing said at least one synthetic water-soluble polymer with said crosslinker. Another group of crosslinking compounds has a molecular weight less than about 7,500 Daltons. Yet another group of cross-linking compounds has a molecular weight less than about 6,000 Daltons. Yet another group of cross-linking compounds has a molecular weight less than about 5,000 Daltons. The water-soluble polymer can be synthetic. Yet another embodiment of the present invention relates to a hydrogel made according the methods.

Yet another embodiment of the present invention relates to a hydrogel material made by polycondensation polymerization of polynucleophilic-polyelectrophilic precursors to form a synthetic water-soluble polymer crosslinked with a non-synthetic water-soluble cyclic crosslinker, wherein the crosslinker is an organic molecule having a molecular weight less than 10,000 Daltons, one core cyclic structure, two or more linking groups attached to the core cyclic structure, and one or more functional groups attached to each linking group. Another group of crosslinking compounds has a molecular weight less than about 7,500 Daltons. Yet another group of cross-linking compounds has a molecular weight less than about 6,000 Daltons. Yet another group of cross-linking compounds has a molecular weight less than about 5,000 Daltons. The water-soluble polymer can be synthetic.

Materials of the invention may be tailored for certain properties, such as compressive strength, adhesion, gel times, and the like. The present invention has a variety of uses including, but not limited to, adhesives, sealants, hemostatic agents, embolization agents, tissue augmentation, adhesion barriers, coating surfaces of medical devices and surgical instruments, and drug delivery matrices.

### BRIEF DESCRIPTION OF THE DRAWINGS

FIG. 1-A is a schematic drawing of a crosslinker molecule, comprising a core cyclic structure with two (2) linking groups “z” attached to the core cyclic structure, with one functional group “x” attached to each linking group where “z” comprises a linking group that is a simple covalent bond or a more complex group.

FIG. 1-B is a schematic drawing of a crosslinker molecule, comprising a core cyclic structure with three (3) linking groups “z” directly attached to the core cyclic structure, with one functional group “x” directly attached to each linking group.

FIG. 1-C is a schematic drawing of a crosslinker molecule, comprising a core cyclic structure with two (2) linking groups “z” directly attached to the core cyclic structure, with one functional group “x” directly attached to one linking group, and two functional groups “x” directly attached to the other linking group.

FIG. 1-D is a schematic drawing of a molecule that does not comprise a cyclic crosslinker of the present invention, wherein one linking group “z” is directly attached to a core cyclic structure, with two functional groups “x” directly attached to the linking group.

FIG. 1-E is a drawing of a preferred cyclic crosslinker having a core cyclic structure, four linking groups attached to the core cyclic structure, and five functional groups directly attached to the linking groups. The linking groups are complex chemical moieties. The compound represented in the Figure is referred to as colistin.

FIG. 1-F is a drawing of a preferred cyclic crosslinker having a core cyclic structure, four linking groups are attached to the core cyclic structure, and six functional groups are directly attached to the linking groups. In this embodiment, two of the linking groups comprise simple covalent bonds and two of the linking groups comprise complex chemical moieties. The compound represented in the Figure is referred to as neomycin.

### DETAILED DESCRIPTION OF THE INVENTION

The present invention relates to hydrogel materials made by way of polycondensation polymerization of polynucleophilic-polyelectrophilic precursors with a cyclic crosslinking compound. The crosslinking compound (i.e., crosslinker) can have a molecular weight less than about 10,000 Daltons, preferably less than about 7,500 Daltons, more preferably less than about 6,000 Daltons, and most preferably less than about 5,000 Daltons. Regardless of the molecular weight, the crosslinking compound should have a relatively small hydrodynamic radius. The crosslinking compound has at most one core cyclic structure. The core cyclic structure has at least two linking groups attached to the core cyclic structure and at least one functional group attached to each linking group.

The present invention addresses all three above-discussed limitations regarding gelation and curing of biocompatible biomaterials via the polycondensation polymerization of polynucleophilic-polyelectrophilic precursors. The invention utilizes at least type of one cyclic compound as a crosslinker. Cyclic compounds of the present invention have a core ring structure with their reactive species attached directly or indirectly to the core ring. Without relying upon any single theory, it is believed a cyclic structure reduces the hydrodynamic radius of the crosslinker molecule compared to linear or branched (e.g., comb-shaped, star-shaped, “Y”-shaped, or “T”-shaped) structures, thereby providing to a higher molecular weight cyclic precursor the enhanced diffusion and reduced viscosity representative of lower molecular weight linear or branched or “star-shaped” molecules. It is also believed the core ring structure reduces steric hindrance by exposing its reactive species so they are no longer in close proximity to another and are not able to fold, or otherwise “burrow,” into the interior of the crosslinking molecule.

The term “in situ gelling” refers to a process of transporting precursor materials of a biomaterial to a target site in a liquid state and causing the precursor materials to change from a liquid state to a gelled state at the target site with the aid of a crosslinking compound having a cyclic conformation. In situ gelling results in a cross-linked, three dimensional, hydrogel-based biomaterials having a variety of applications.

The term “cyclic” refers to an organic molecule having a ring structure. The present invention utilizes a cyclic crosslinker having at most one central ring structure, referred to herein as a “core ring structure.” Core ring structures have at least five atoms in the backbone of the ring. Examples of compounds having core ring structures include, but are not limited, to cyclic alkanes, cyclic aromatics, monosaccharides, glycosides, aminoglycosides, glycosylamines, cyclic polypeptides, and their combinations.

The term “linking group” refers to a simple chemical bond directly attaching a functional group to the core cyclic structure. Alternatively, the term “linking group” refers to a complex chemical moiety indirectly attaching the functional group to the core cyclic structure. The linking group may comprise complex chemical moieties having linear structures, branched structures, ring structures, aliphatic ring structures, and aromatic ring structures. Linking groups are directly covalently bonded to the core cyclic structure. Examples of linking groups include linear structures such as alkanes, carbonyls, ethers, amides, esters, carbonates, urethanes; branched structures; ring structures such as cyclic alkanes, cyclic aromatics, monosaccharides, glycosides, aminoglycosides, glycosylamines, cyclic polypeptides, aliphatic ring structures, and aromatic ring structures.

The term “functional group” refers to a reactive chemical species able to participate in a polycondensation polymerization reaction. Functional groups are directly or indirectly attached to the linking groups. Each precursor is water-soluble and multifunctional having two or more electrophilic or nucleophilic functional groups such that a nucleophilic functional group on one precursor may react with an electrophilic functional group on another precursor to form a covalent bond. Preferably, each precursor comprises only nucleophilic or only electrophilic functional groups. Thus, for example, if a cyclic crosslinking compound (i.e., cyclic crosslinker) has nucleophilic functional groups such as amines, the water-soluble polymer may have electrophilic functional groups such as N-hydroxysuccinimide esters. On the other hand, if a cyclic crosslinker has electrophilic functional groups such as N-hydroxysuccinimide esters, then the functional polymer may have nucleophilic functional groups such as amines. Certain functional groups, such as alcohols or carboxylic acids, do not normally react with other functional groups, such as amines, under physiological conditions. However, such functional groups can be made more reactive by using methods well known to the art, such as the use of an activating group such as N-hydroxysuccinimide and di(N-succinimidyl)carbonate. Examples of functional groups include nucleophilic groups such as amines, alcohols, alkoxides, thiols, guanidine; and electrophilic groups such as esters, succinimidyl esters, alkyl isocyanates, aromatic isocyanates, aldehydes, carbonates, succinimidyl carbonates, succinimidyl carbamates, epoxides, and carbodiimides. Amines are preferred nucleophilic groups. Succinimidyl esters and succinimidyl carbonates are preferred electrophilic groups.

Preferred water-soluble polymers include polyethers such as polyalkylene oxides like polyethylene glycol (“PEG”), polyethylene oxide, polyethylene oxide-co-polypropylene oxide, co-polyethylene oxide block or random copolymers, polyvinyl alcohol, poly(vinyl pyrrolidinone), poly(amino acids), dextran, heparin, polysaccharides, and the like. Polyethers, more particularly PEG, are preferred.

Cyclic crosslinkers and water-soluble polymers having linking groups, functional groups, or cyclic core structures can be biodegradable. Such materials may be used to form a biocompatible crosslinked biomaterial that is biodegradable or bioresorbable. Biodegradable groups may be chosen such that the resulting biodegradable biocompatible crosslinked biomaterial will degrade or be absorbed in a desired period of time. Preferably, biodegradable linkages are selected that degrade under physiological conditions into non-toxic products. The biodegradable group may be chemically or enzymatically hydrolyzable or absorbable. Chemically hydrolyzable biodegradable groups include polymers, copolymers and oligomers of glycolide, lactide, caprolactone, dioxanone, trimethylene carbonate, succinate, glutarate, and the like. Enzymatically hydrolyzable biodegradable groups include peptide linkages and saccharide linkages. Additional biodegradable groups include polymers and copolymers of polyhydroxy acids, polyorthocarbonates, polyanhydrides, polylactones, polyaminoacids, polycarbonates, and polyphosphonates.

The in situ gelling of a biocompatible biomaterial via the polycondensation polymerization of polynucleophilic-polyelectrophilic precursors preferably occurs in aqueous solution under physiological conditions. Preferably, the crosslinking reactions do not release heat of polymerization. The reaction conditions for crosslinking depend on the nature of the functional groups. Preferred reactions are conducted in buffered aqueous solutions at pH 5 to pH 12. Preferred buffers are sodium borate buffer (pH 10-11) and sodium phosphate buffer (pH 4-5). Organic solvents such as ethanol, methylpyrrolidone, or dimethylsulfoxide, may be added to adjust the reaction speed or to adjust the viscosity of a given formulation.

As previously mentioned, the cyclic crosslinker used in the present invention has a molecular weight less than about 10,000 Daltons, preferably less than about 7,500 Daltons, more preferably less than about 6,000 Daltons, and most preferably less than about 5,000 Daltons.

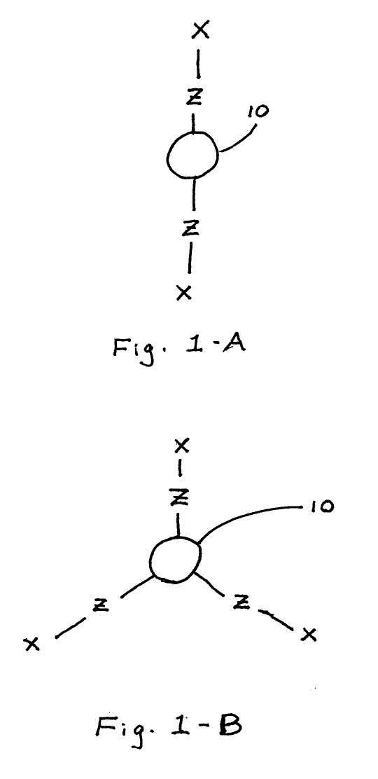

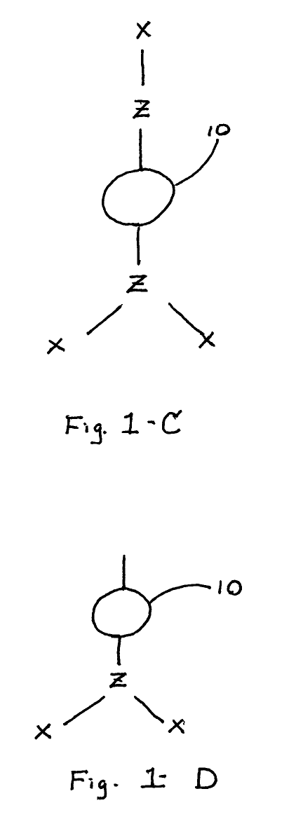

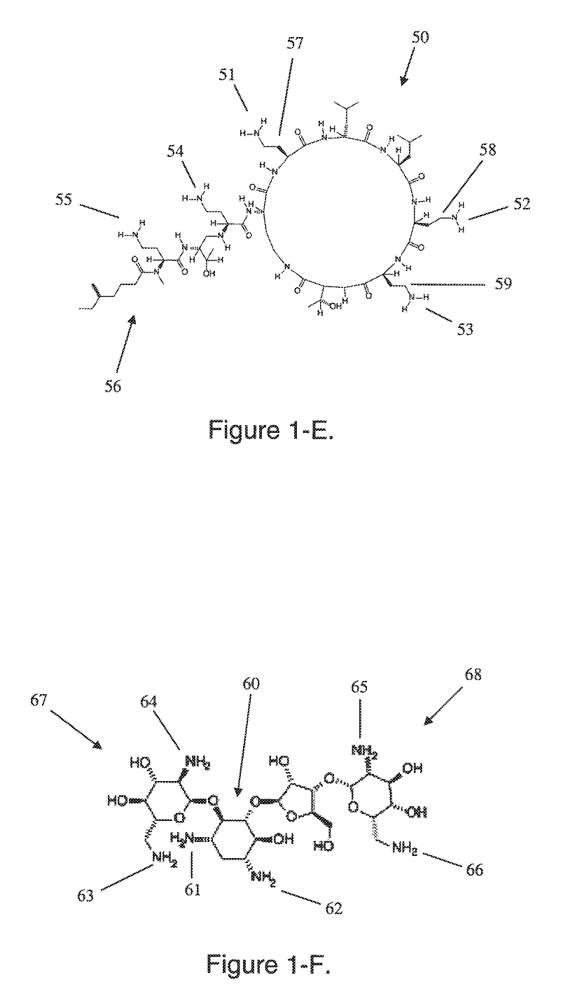

Referring to FIG. 1-A, a cyclic crosslinker contains at most one core cyclic structure (10), with at least two linking groups (“z”) directly attached to the core cyclic structure (10) and at least one functional group (“x”) directly or indirectly attached to each linking group (“z”) where “z” comprises a linking group that is a simple covalent bond or a more complex moiety.

Referring to FIG. 1-B, core cyclic structure (10) is shown with three linking groups “z” attached to the core cyclic structure (10). Each linking group “z” contains one functional group “x”. Linking group “z” is a simple covalent bond or a more complex moiety.

Referring to FIG. 1-C, core cyclic structure (10) is shown with two linking groups “z” attached to the core cyclic structure (10). One of the linking groups “z” contains one functional group “x”. The other linking group “z” contains two functional groups. Linking groups “z” are simple covalent bonds or a more complex moiety.

Preferred crosslinkers are aminoglycosides and cyclic polypeptides. Aminoglycosides have at most one core cyclic glycosidic structure, with multiple amino groups attached to the core cyclic structure via simple covalent bonds and via intermediary glycosidic structures. Examples of aminoglycosides include neomycin, amikacin, apramycin, arbekacin, butrirosin, dibekacin, gentamycin, kanamycin, paromomycin, tobramycin, fortimicin, isepramicin, micronomicin, neamine, ribostamycin, sisomycin, and the like. Neomycin is particularly preferred.

Cyclic polypeptides can have a backbone of polyamino acids that loops back upon itself to form at most one core cyclic structure. Polycationic cyclic polypeptides have functional groups, such as amines, that are attached to the core cyclic structure via linking groups such as simple covalent bonds, lysine residues, ornithine residues, diaminobutane, diaminobutyric acid, aminobutyric acid, and the like. Examples of cyclic polypeptides include colistin, polymyxin, polymyxin B nonapeptide, cyclic polylysine, bacitracin, daptomycin, octreotide, nisin, and the like. Colistin is particularly preferred.

Other cyclic crosslinkers include polycationic dyes such as Bismark Brown, polyzwitterionic dyes such as Congo Red, macrocyclic compounds such as aminocyclodextran, and aromatic polyamines such as melamine.

Referring to FIG. 1-E, the structure shown is a preferred cyclic crosslinker having a cyclic polypeptide molecule. Colistin has one core cyclic structure (50), an attached tail (56) having an alkyl threonyl diaminobutyrate moiety, and five functional amine groups (51, 52, 53, 54, 55) attached to the core cyclic structure (50). Amine functional groups 51, 52, and 53 are attached to the core cyclic structure 50 via three individual linking groups having buturyl moieties (57, 58, 59). Amine functional groups 54 and 55 are attached to the core cyclic structure 50 via a linking group comprising tail 56.

Referring to FIG. 1-F, the structure shown is a preferred cyclic crosslinker comprising a cyclic aminoglycoside molecule. Neomycin comprises multiple ring structures, with one six-carbon ring structure comprising the core cyclic structure (60). A total of 6 amine functional groups are linked to the core cyclic structure (60). Amine functional groups 61 and 62 are attached to core cyclic structure 60 via linking groups having simple covalent bonds. Amine functional groups 63 and 64 are attached to core cyclic structure 60 via a linking group having a glucopyranosyl moiety (67). Amine functional groups 65 and 66 are attached to core cyclic structure 60 via a linking group having a neobiosamine moiety (68).

The biocompatible crosslinked biomaterials and their precursors described above may be used in a variety of applications, such as components for embolic agents to reduce blood flow in a variety of medical procedures, including treatment of uterine fibroid tumors, treatment of arteriovenous malformations and fistulae, filling and sealing aneurysmal sac endoleaks, occluding tubular vessels, and sealing of punctures. In addition to hemostatic agents and sealants, biocompatible crosslinked biomaterials can be used to coat organs, form implantable articles, and deliver drugs.

In many applications, the biocompatible crosslinked biomaterials of the present invention will be cured or gelled directly at the implant site via in situ gelation. Prior to gelling, in situ gelling biomaterials are in a liquid state during transportation to a delivery site. At a delivery site, the components are directly cured or gelled to a crosslinked, three dimensional, material. The various methodologies and devices for performing in situ gelation developed for other adhesive or sealant systems such fibrin glue or sealant applications may be used with the biocompatible crosslinked biomaterials of the present invention, including commercially available devices such as Duploject® Applicator System (Baxter), Duoflo® Manual Spray Set (Baxter), and Duplocath® Application Catheters (Baxter). In one embodiment, an aqueous solution of a freshly prepared cyclic crosslinker (e.g., colistin sulfate, a polynucleophilic cyclic polypeptide having five amines in a sodium borate buffer solution at pH 10) and a functional water soluble polymer (e.g., PEG terminated with succinimidyl esters in a sodium phosphate buffer solution at pH 5) are applied and mixed on the tissue using a double barrel syringe (one syringe for each solution). The two solutions may be applied simultaneously or sequentially. In another embodiment, an aqueous solution of a freshly prepared cyclic crosslinker (e.g., colistin sulfate, a polynucleophilic cyclic polypeptide comprising five amines in a sodium borate buffer solution at pH 10) and a functional water soluble polymer (e.g., PEG terminated with succinimidyl esters in a sodium phosphate buffer solution at pH 5) are applied and mixed on the tissue using a dual lumen catheter (one lumen for each solution). The two solutions may be applied simultaneously or sequentially.

The biocompatible crosslinked biomaterials of the instant invention may be reinforced with fibers, meshes, felts, and the like. Alternatively, the biocompatible crosslinked biomaterials of the instant invention may be used to fill the void space of porous materials such as porous expanded polytetrafluoroethylene (ePTFE) and porous PGA/TMC materials. Such composite materials have improved mechanical properties like flexibility, strength, and tear resistance. In a preferred embodiment, aqueous solutions of the precursors are mixed in appropriate buffers and added to a porous biomaterial such as PGA/TMC mesh materials, made according to U.S. Patent Publication 2007/0027550 A1, which is incorporated herein by reference. While in a liquid state, the precursors flow into the interior of the membrane and then undergo a crosslinking reaction to produce a composite hydrogel.

The biocompatible crosslinked biomaterials of the present invention may be used for localized drug therapy. Biologically active agents or other pharmaceutical compounds may be added to and delivered from the hydrogel material. These agents and compounds include, but are not limited to, peptides, proteins, glycosaminoglycans, carbohydrates, nucleic acids, enzymes, antibiotics, antineoplastic agents, local anesthetics, hormones, angiogenic agents, anti-angiogenic agents, growth factors, antibodies, neurotransmitters, psychoactive drugs, anticancer drugs, chemotherapeutic drugs, drugs affecting reproductive organs, genes, and oligonucleotides.

The bioactive compounds are mixed with the precursors prior to in situ gelling of the biocompatible crosslinked biomaterial. Upon gelation, a crosslinked biomaterial having the biologically active substance entrapped therein is produced. Additives such as emulsifiers, compatibilizers, biocompatible detergents, microspheres, microparticles, biodegradable microspheres, biodegradable microparticles, molecular sieves, rotaxanes, polyrotaxanes, and the like, may also be mixed with the precursors to aid entrapment, encapsulation, and delivery of the bioactive compounds. The polycondensation polymerization between the cyclic crosslinker and the water soluble polymer forms a crosslinked hydrogel material that acts as a depot for release of the active agent. Optionally, the bioactive agent may be covalently attached to the biocompatible crosslinked biomaterial using conventional methods. The nature of the covalent attachment can control the release rate of the bioactive agent from the crosslinked biomaterial. By using a composite made from linkages with a range of hydrolysis times, a controlled release profile may be generated that extends for a significant length of time.

Such methods of drug delivery find use in both systemic and local administration of an active agent. Use of the materials of the present invention for drug delivery requires the amount of water soluble polymer, cyclic crosslinker, and the bioactive agent introduced in the host be adjusted based on the particular condition being treated. Administration may be by any convenient means such as syringe, canula, trocar, catheter and the like.

### EXAMPLES

### Example 1

This example describes formation of a material of the present invention. Polyethylene glycol succinimidyl succinate (molecular weight 2000; SunBio, Inc.), a polyelectrophilic PEG having two succinimidyl esters, was dissolved at a concentration of 0.2 g/ml in a sodium phosphate buffer solution, pH 5.0. 100 μl of this solution was placed into the bottom of a test tube and stirred with a magnetic mixing bar. Polymyxin B nonapeptide (Sigma), a polynucleophilic cyclic polypeptide comprising five amines, was dissolved at a concentration of 37 mg/ml in a sodium borate buffer solution, pH 9.5. 100 μl of this solution was added to the test tube with stirring from the magnetic mixing bar to provide a 1:1 stoichiometry of electrophilic groups:nucleophilic groups. The mixture formed a hydrogel within thirty seconds (30 sec. cure).

### Example 2

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Colistin sulfate (Sigma), a polynucleophilic cyclic polypeptide having five amines, was dissolved at a concentration of 79 mg/ml in a sodium borate buffer solution, pH 9.5. 100 μl of this solution was added to the test tube with stirring from the magnetic mixing bar to provide a 1:1 stoichiometry of electrophilic groups:nucleophilic groups. The mixture formed a hydrogel within three seconds (3 sec. cure).

### Example 3

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.3 g/ml in a sodium phosphate buffer solution, pH 5.0. 100 μl of this solution was placed into the bottom of a test tube. Colistin sulfate (Sigma), a polynucleophilic cyclic polypeptide having five amines, was dissolved at a concentration of 58 mg/ml in a sodium borate buffer solution, pH 9.5. 100 μl of this solution was added to the test tube with vortexing to provide a 1:1 stoichiometry of electrophilic groups:nucleophilic groups. The mixture formed a hydrogel within one second (1 sec. cure).

### Example 4

This example describes formation of a material of the present invention. Polyethylene glycol succinimidyl succinate (molecular weight 3400; SunBio, Inc.), a polyelectrophilic PEG comprising two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Colistin sulfate (Sigma), a polynucleophilic cyclic polypeptide having five amines, was dissolved at a concentration of 79 mg/ml in a sodium borate buffer solution, pH 9.5. 100 μl of this solution was added to the test tube with stirring from the magnetic mixing bar to provide a 1:1 stoichiometry of electrophilic groups:nucleophilic groups. The mixture formed a hydrogel within two seconds (2 sec. cure).

### Example 5

This example describes formation of a material of the present invention. Polyelectrophilic PEG having two isocyanates was prepared by reacting 151.5 grams of polyethylene glycol, molecular weight 1450 (Carbowax Sentry, Dow Chemical), with 50.5 grams of methylene diphenyl diisocyanate (Rubinate 44, Huntsman), for two hours (2 hrs) at ninety degrees Centigrade (90° C.). The resulting product was PEG diisocyanate.

### Example 6

This example describes formation of a material of the present invention. The PEG diisocyanate of Example 5 was dissolved in DMSO at a concentration of 0.2 g/ml. 100 μl of this solution was placed into the bottom of a test tube and stirred with a magnetic mixing bar. Colistin sulfate (Sigma), a polynucleophilic cyclic polypeptide having five amines, was dissolved at a concentration of 66 mg/ml in a sodium borate buffer, pH 9.5. 100 μl of this solution was added to the test tube with stirring from the magnetic mixing bar to provide a 1:1 stoichiometry of electrophilic groups:nucleophilic groups. The mixture formed a hydrogel within eleven seconds (11 sec. cure) with minimal foam generation, indicating minimal hydrolysis of the isocyanate functional groups during crosslinking.

### Example 7

This example describes formation of a material of the present invention. The PEG diisocyanate of Example 5 was dissolved in DMSO at a concentration of 0.2 g/ml. 100 μl of this solution was placed into the bottom of a test tube and stirred with a magnetic mixing bar. Colistin sulfate (Sigma), a polynucleophilic cyclic polypeptide having five amines, was dissolved at a concentration of 150 mg/ml in a sodium borate buffer, pH 9.5. 100 μl of this solution was added to the test tube with stirring from the magnetic mixing bar to provide a 1:2 stoichiometry of electrophilic groups:nucleophilic groups. The mixture formed a hydrogel within one second (1 sec. cure) without foam generation, indicating minimal hydrolysis of the isocyanate functional groups during crosslinking.

### Example 8

This example describes formation of a material of the present invention. Polyelectrophilic PEG having three succinimidyl esters was prepared by reacting 97.8 grams of 3-arm polyethylene glycol (molecular weight 3500, PolyG 83-48, Arch Chemicals), with 8.4 grams of succinic anhydride (Sigma) in refluxing toluene for twenty-four hours (24 hrs). The resulting product, PEG trisuccinate, was recovered by multiple ether/toluene precipitation and rotovaporation drying. 77.8 g of the PEG trisuccinate was then reacted with 7.1 grams of N-hydroxysuccinimide (Pierce) and 13.8 ml of dicyclohexylcarbodiimide (Pierce), in ethyl acetate, at zero degrees Centigrade (0° C.) for three hours (3 hrs), then at room temperature for an additional fifteen hours (15 hrs). The urea byproduct was removed by filtration and the resulting product, PEG trisuccinimidyl trisuccinate, was obtained by multiple ether/ethyl acetate precipitation and rotovaporation.

### Example 9

The PEG trisuccinimidyl trisuccinate of Example 8 was dissolved at a concentration of 0.5 g/ml in a sodium phosphate buffer solution, pH 5.0. 100 μl of this solution was placed into the bottom of a test tube, and stirred with a magnetic mixing bar. Colistin sulfate (Sigma), a polynucleophilic cyclic polypeptide comprising five amines, was dissolved at a concentration of 84 mg/ml in a sodium borate buffer solution, pH 9.5. 100 μl of this solution was added to the test tube with stirring from the magnetic mixing bar to provide a 1:1 stoichiometry of electrophilic groups:nucleophilic groups. The mixture formed a hydrogel within two seconds (2 sec. cure).

### Example 10

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Neomycin sulfate USP (Spectrum Chemical), a polynucleophilic cyclic aminoglycoside having six amines, was dissolved at a concentration of 34 mg/ml in a sodium borate buffer solution, pH 11.0. 100 μl of this solution was added to the test tube with stirring from the magnetic mixing bar to provide a 1:1 stoichiometry of electrophilic groups:nucleophilic groups. The mixture formed a hydrogel within eight seconds (8 sec. cure).

### Example 11

This example describes formation of a material of the present invention. Polyethylene glycol succinimidyl glutarate (molecular weight 3400; SunBio, Inc.), a polyelectrophilic PEG comprising two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Paromomycin sulfate USP (Spectrum Chemical), a polynucleophilic cyclic aminoglycoside having five amines, was dissolved at a concentration of 31 mg/ml in a sodium borate buffer solution, pH 11.0. 100 μl of this solution was added to the test tube with stirring from the magnetic mixing bar to provide a 1:1 stoichiometry of electrophilic groups:nucleophilic groups. The mixture formed a hydrogel within thirty seconds (30 sec. cure).

### Example 12

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Amikacin sulfate USP (Spectrum Chemical), a polynucleophilic cyclic aminoglycoside having four amines, was dissolved at a concentration of 43 mg/ml in a sodium borate buffer solution, pH 11.0. 100 μl of this solution was added to the test tube with stirring from the magnetic mixing bar to provide a 1:1 stoichiometry of electrophilic groups:nucleophilic groups. The mixture formed a hydrogel within forty-five seconds (45 sec. cure).

### Example 13

This example describes formation of a material of the present invention. Polyethylene glycol succinimidyl succinate (molecular weight 3400; SunBio, Inc.), a polyelectrophilic PEG having two succinimidyl esters, was dissolved at a concentration of 0.38 g/ml in a sodium phosphate buffer solution, pH 5.0. 100 μl of this solution was placed into the bottom of a test tube and stirred with a magnetic mixing bar. Neomycin sulfate USP (Spectrum Chemical), a polynucleophilic cyclic aminoglycoside having six amines, was dissolved at a concentration of 50 mg/ml into sodium borate buffer, pH 11.0. 100 μl of this solution was added to the test tube with stirring from the magnetic mixing bar to provide a 1:1 stoichiometry of electrophilic groups:nucleophilic groups. The mixture formed a hydrogel within seven seconds (7 sec. cure).

### Example 14

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Neomycin sulfate USP (Spectrum Chemical), a polynucleophilic cyclic aminoglycoside having six amines, was dissolved at a concentration of 34 mg/ml into sodium borate buffer, pH 9.5. 100 μl of this solution was added to the test tube with stirring from the magnetic mixing bar to provide a 1:1 stoichiometry of electrophilic groups:nucleophilic groups. The mixture formed a hydrogel within fifty seconds (50 sec).

### Example 15

This example describes formation of a material of the present invention. Six-arm polyethylene glycol hexaepoxide (molecular weight 10,000; SunBio, Inc.), a polyelectrophilic PEG having six epoxides, was dissolved at a concentration of 0.4 g/ml in a sodium phosphate buffer solution, pH 5.0. 100 μl of this solution was placed into the bottom of a test tube and stirred with a magnetic mixing bar. Neomycin sulfate USP (Spectrum Chemical), a polynucleophilic cyclic aminoglycoside having six amines, was dissolved at a concentration of 35 mg/ml into sodium borate buffer, pH 11.0. 100 μl of this solution was added to the test tube with stirring from the magnetic mixing bar to provide a 1:1 stoichiometry of electrophilic groups:nucleophilic groups. The mixture formed a hydrogel within two hours (2 hr).

### Example 16

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Colistin sulfate (Sigma), a polynucleophilic cyclic polypeptide having five amines, was dissolved at a concentration of 63 mg/ml in a sodium phosphate buffer solution, pH 5.0. 100 μl of this solution was added to the test tube with stirring from the magnetic mixing bar to provide a 1:1 stoichiometry of electrophilic groups:nucleophilic groups. Owing to the low pH of the mixture, no reaction was seen to occur between the polyelectrophilic groups and the polynucleophilic groups and no hydrogel formed within five hours (5 hrs).

### Example 17

This example describes formation of a material of the present invention. 100 μl of freshly prepared mixtures from Example 16 was added to a test tube with a magnetic mixing bar. The mixture was incubated at room temperature for 0 hr, 1 hr, 2 hr, and 4 hr. At the specified time, 100 μl of a sodium borate buffer solution of varying pH was added to the test tube with mixing. The mixture formed a gel according to Table 1 below.

TABLE 1

| | time to gel after: | | | | |
|---|---|---|---|---|---|
| pH | 0 hr incubation | 1 hr incubation | | 2 hr incubation | 4 hr incubation |
| 11.0 | <1 sec | <1 | sec | * | * |
| 10.5 | 1 sec | 1 | sec | 2 sec | 3 sec |
| 10.0 | 1 sec | 2 | sec | * | * |
| 9.5 | 2 sec | 3 | sec | * | * |
| 9.0 | 5 sec | 6 | sec | 14 sec | 20 sec |
| 8.5 | * | 2 | min | * | * |
| 8.0 | * | 4 | hr | * | * |

*: not determined

### Example 18

This example describes formation of a material of the present invention. Polyethylene glycol succinimidyl succinate (molecular weight 2000; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Colistin sulfate (Sigma), a polynucleophilic cyclic polypeptide having five amines, was dissolved at a concentration of 109 mg/ml in a sodium phosphate buffer solution, pH 5.0. 100 μl of this solution was added to the test tube with stirring from the magnetic mixing bar, to provide a 1:1 stoichiometry of electrophilic groups:nucleophilic groups. 100 μl of sodium borate buffer of varying pH was added to the test tube with mixing. The mixture formed a gel according to Table 2 below.

TABLE 2

| pH | time to gel | |
|---|---|---|
| 11.0 | 1 | sec |
| 10.5 | 2 | sec |
| 10.0 | 3 | sec |
| 9.5 | 15 | sec |
| 9.0 | 7.5 | min |

### Example 19

This example describes formation of a material of the present invention. Polyethylene glycol succinimidyl succinamide, a polyelectrophilic PEG comprising two succinimidyl esters, was prepared by reacting 8.9 g of polyethylene glycol-bis(3-aminopropyl) (molecular weight 1535; Sigma) with 1.12 g of succinic anhydride (Sigma) in 30.5 ml of tetrahydrofuran, at room temperature under nitrogen for seventeen hours (17 hrs). Solvent was removed by rotovaporation, and the PEG-disuccinamide product was recovered by multiple solvent/nonsolvent precipitation into tetrahydrofuran/cold hexane. Amide formation was confirmed by FTIR.

6.8 g of the PEG-disuccinamide was dissolved in 35 ml of anhydrous dimethylformamide (Fisher), along with 1.0 g of N-hydroxysuccinimide (Pierce) was added. After cooling to 0° C., 1.78 g of dicyclohexycarbodiimide (Pierce), dissolved in three milliliters (3 ml) of anhydrous dimethylformamide, was added dropwise with stirring under nitrogen. The reaction was maintained at 0° C. for six hours (6 hrs), then at 25° C. for an additional seventeen hours (17 hrs). The solution was filtered to remove urea byproduct, and the PEG succinimidyl succinamide product recovered by multiple solvent/nonsolvent precipitations with toluene/cold hexane. Solvent was removed with rotovaporation.

### Example 20

The polyethylene glycol succinimidyl succinamide (molecular weight 1809) formed in Example 19 is dissolved at 0.4 g/ml in a sodium phosphate buffer, pH 5.0. 100 μl of this solution is placed into the bottom of a test tube and stirred with a magnetic mixing bar. Colistin sulfate USP (Spectrum Chemical), a polynucleophilic cyclic aminoglycoside comprising five amines, is dissolved at 34 mg/ml in a sodium borate buffer, pH 11.0. 100 μl of this solution is added to the test tube with stirring from the magnetic mixing bar to provide a 1:1 stoichiometry of electrophilic groups:nucleophilic groups. The mixture is seen to form a gel within one minute (1 min cure).

### Example 21

This example describes formation of a material of the present invention. Polyethylene glycol succinimidyl glutarate (molecular weight 3400; SunBio, Inc.), a polyelectrophilic PEG having two succinimidyl esters, was dissolved at 0.4 g/ml into sodium phosphate buffer, pH 5.0. 100 μl of this solution was placed into the bottom of a test tube, and stirred with a magnetic mixing bar. Neomycin sulfate (Sigma), a polynucleophilic cyclic aminoglycoside having six amines, was dissolved at 34 mg/ml into sodium phosphate buffer, pH 5.0. 100 μl of this solution was added to the test tube with stirring from the magnetic mixing bar, to provide a 1:1 stoichiometry of electrophilic groups:nucleophilic groups. 100 μl of sodium borate buffer of varying pH, was added to the test tube with mixing. The mixture formed a gel according to Table 3 below.

TABLE 3

| pH | time to gel | |
|---|---|---|
| 11.0 | 8 | sec |
| 10.5 | 13 | sec |
| 10.0 | 22 | sec |
| 9.5 | 50 | sec |
| 9.0 | 2 | min |
| 8.5 | 15 | min |

### Example 22

This example describes formation of a material of the present invention. Polyethylene glycol succinimidyl succinate (molecular weight 3400; SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Neomycin sulfate (Sigma), a polynucleophilic cyclic aminoglycoside having six amines, was dissolved at a concentration of 36 mg/ml in a sodium phosphate buffer solution, pH 5.0. 100 μl of this solution was added to the test tube with stirring from the magnetic mixing bar to provide a 1:1 stoichiometry of electrophilic groups:nucleophilic groups. 100 μl of sodium borate buffer of varying pH was added to the test tube with mixing. The mixture formed a gel according to Table 4 below.

TABLE 4

| pH | time to gel | |
|---|---|---|
| 11.0 | 8 | sec |
| 10.5 | 9 | sec |
| 10.0 | 13 | sec |
| 9.5 | 22 | sec |
| 9.0 | 1.5 | min |
| 8.5 | 8 | min |

### Example 23

This example describes formation of a material of the present invention. Polyethylene glycol succinimidyl glutarate (molecular weight 3400 (SunBio, Inc.), a polyelectrophilic PEG having two succinimidyl esters, was dissolved at a concentration of 0.4 g/ml in a sodium phosphate buffer solution, pH 5.0. 100 μl of this solution was placed into the bottom of a test tube and stirred with a magnetic mixing bar. Polymyxin B sulfate (Sigma), a polynucleophilic cyclic polypeptide having five amines, was dissolved at a concentration of 77 mg/ml in a sodium phosphate buffer solution, pH 5.0. 100 μl of this solution was added to the test tube with stirring from the magnetic mixing bar to provide a 1:1 stoichiometry of electrophilic groups:nucleophilic groups. 100 μl of sodium borate buffer of varying pH was added to the test tube with mixing. The mixture formed a gel according to Table 5 below.

TABLE 5

| pH | time to gel | |
|---|---|---|
| 11.0 | 5 | sec |
| 10.5 | 5 | sec |
| 10.0 | 5 | sec |
| 9.5 | 10 | sec |
| 9.0 | 21 | sec |
| 8.5 | 1.3 | min |
| 8.0 | 8 | min |

### Example 24

This example describes formation of a material of the present invention. Polyethylene glycol succinimidyl succinate (molecular weight 3400; SunBio, Inc.), a polyelectrophilic PEG having two succinimidyl esters, was dissolved at a concentration of 0.4 g/ml in a sodium phosphate buffer solution, pH 5.0. To one milliliter (1 ml) of this solution was added thirty-six milligrams (36 mg) of neomycin sulfate (Spectrum) to provide a 1:1 stoichiometry of electrophilic groups:nucleophilic groups. The solution was loaded into a first three cubic centimeter (3 cc) syringe (Baxter). Sodium borate buffer, pH 11.0, was loaded into a second three cubic centimeter (3 cc) syringe (Baxter). The two syringes were assembled into a dual-syringe sprayer (Duploject, Baxter) and fitted with a 23 mm×1.5 mm mixing needle (Becton Dickson). Upon expression of the contents of the syringes, a gelled bead extruded from the tip of the needle.

### Example 25

This example describes formation of a material of the present invention. Polyethylene glycol succinimidyl succinate (molecular weight 3400; SunBio, Inc.), a polyelectrophilic PEG having two succinimidyl esters, was dissolved at 0.4 g/ml in a sodium phosphate buffer, pH 5.0. To one milliliter (1 ml) of this solution was added sixty-six milligrams (66 mg) of colistin sulfate (Sigma) to provide a 1:1 stoichiometry of electrophilic groups:nucleophilic groups. The solution was loaded into a first three cubic centimeter (3 cc) syringe (Baxter). Sodium borate buffer, pH 9.5, was loaded into a second three cubic centimeter (3 cc) syringe (Baxter). The two syringes were assembled into a dual-syringe sprayer (Duploject, Baxter) and fitted with a 23 mm×1.5 mm mixing needle (Becton Dickson). Upon expression of the contents of the syringes, a gelled bead extruded from the tip of the needle.

### Example 26

This example describes formation of a material of the present invention. Polyethylene glycol succinimidyl carbonate (molecular weight 3400; Laysan, Inc.), a polyelectrophilic PEG comprising two succinimidyl carbonates, was dissolved at 0.4 g/ml in a sodium phosphate buffer, pH 5.0, and loaded into one-half of a 2 cc mini-dual syringe (Plas-Pak Industries, Inc.). Neomycin sulfate USP (Spectrum) was dissolved at 45 mg/ml in a sodium borate buffer, pH 11.0, and loaded into the other half of the mini-dual syringe. A micro static mixer (Plas-Pak Industries, Inc.) was attached to the dual syringes. Upon expression of the syringes, a viscous mixture extruded from the static mixer tip. The viscous mixture was directed onto a plastic petri dish to form a hydrogel within four seconds (4 sec. cure).

### Example 27

This example describes formation of a material of the present invention. Polyethylene glycol succinimidyl carbonate (molecular weight 3400; Laysan, Inc.), a polyelectrophilic PEG comprising two succinimidyl carbonates, was dissolved at 1.44 g into three milliliters (3 ml) of a sodium phosphate buffer, pH 5.0. 99 mg of neomycin sulfate USP (Spectrum) was added with vortexing. The mixture was placed into a first three cubic centimeter (3 cc) syringe (Becton-Dickinson) and connected to the hub of a 0.019″ OD microcatheter (Hydrolink Detach, Microvention). A solution of sodium borate, pH 10.5, was placed into a second three cubic centimeter (3 cc) syringe and connected to the hub of a 0.027″ ID microcatheter (Renegade, Boston Scientific). The 0.019″ microcatheter was inserted into the lumen of the 0.027″ microcatheter to provide a dual lumen coaxial orientation with the outer tube projecting one millimeter (1 mm) beyond the inner tube. The syringes were connected to syringe pumps (Medifusion; Harvard Apparatus), programmed to express at 333 μl/min. A viscous mixture extruded from the dual lumen coaxial microcatheter tip. The viscous mixture was directed onto a plastic petri dish and formed a hydrogel within ten seconds (10 sec. cure).

### Example 28

This example describes formation of a material of the present invention. Polyethylene glycol succinimidyl succinate (molecular weight 3400; SunBio, Inc.), a polyelectrophilic PEG having two succinimidyl esters, was dissolved at a concentration of 0.4 g/ml in a sodium phosphate buffer solution, pH 5.0. To one milliliter (1 ml) of this solution was added thirty-six milligrams (36 mg) of neomycin sulfate USP (Spectrum) to provide a 1:1 stoichiometry of electrophilic groups: nucleophilic groups. The solution was loaded into a first three cubic centimeter (3 cc) syringe (Baxter). Sodium borate buffer, pH 11.0, was loaded into a second three cubic centimeter (3 cc) syringe (Baxter). The two syringes were assembled into a dual-syringe sprayer (Duploject, Baxter), and fitted with a mixing nozzle and atomizer tip (Duoflo, Baxter). Upon expression of the syringes, a fine mist spray extruded from the atomizer tip. The spray was directed onto a glass petri dish and formed a thin film that gelled in ten seconds (10 sec. cure).

### Example 29

This example describes formation of a material of the present invention. Polyethylene glycol succinimidyl glutarate (molecular weight 3400; SunBio, Inc.), a polyelectrophilic PEG having two succinimidyl esters, was dissolved at a concentration of 0.4 g/ml in a sodium phosphate buffer solution, pH 5.0. To one milliliter (1 ml) of this solution was added sixty milligrams (60 mg) of colistin sulfate (Sigma) to provide a 1:1 stoichiometry of electrophilic groups:nucleophilic groups. The solution was loaded into a first three cubic centimeter (3 cc) syringe (Baxter). Sodium borate buffer, pH 10.0, was loaded into a second three cubic centimeter (3 cc) syringe (Baxter). The two syringes were assembled into a dual-syringe sprayer (Duploject, Baxter), and fitted with a mixing nozzle and atomizer tip (Duoflo, Baxter). Upon expression of the syringes, a fine mist spray extruded from the atomizer tip. The spray was directed onto a glass petri dish and formed a thin film that gelled in three seconds (3 sec. cure).

### Example 30

This example describes formation of a material of the present invention. Polyethylene glycol succinimidyl succinate (molecular weight 3400; SunBio, Inc.), a polyelectrophilic PEG having two succinimidyl esters, was dissolved at a concentration of 0.4 g/ml in a sodium phosphate buffer solution, pH 5.0. To one milliliter (1 ml) of this solution was added thirty-six milligrams (36 mg) of neomycin sulfate USP (Spectrum) to provide a 1:1 stoichiometry of electrophilic groups: nucleophilic groups. The solution was loaded into a first three cubic centimeter (3 cc) syringe (Baxter). Sodium borate buffer, pH 11.0, was loaded into a second three cubic centimeter (3 cc) syringe (Baxter). The two syringes were assembled into a dual-syringe sprayer (Duploject, Baxter), and fitted with a mixing nozzle and atomizer tip (Duoflo, Baxter). Upon expression of the syringes, a fine mist spray extruded from the atomizer tip. The spray was directed onto a glass petri dish and formed a thin film that gelled in ten seconds (10 sec cure).

### Example 31

This example describes formation of a material of the present invention. Polyethylene glycol succinimidyl carbonate (Laysan, Inc.), a polyelectrophilic PEG having two succinimidyl carbonates and a molecular weight of 3,400, was dissolved at a concentration of 0.4 g/ml in a sodium phosphate buffer solution, pH 5.0. To one milliliter (1 ml) of this solution was added sixty-three milligrams (63 mg) of colistin sulfate (Sigma) to provide a 1:1 stoichiometry of electrophilic groups: nucleophilic groups. The solution was loaded into a first three cubic centimeter (3 cc) syringe (Baxter). Sodium borate buffer, pH 9.5, was loaded into a second three cubic centimeter (3 cc) syringe (Baxter). The two syringes were assembled into a dual-syringe sprayer (Duploject, Baxter), fitted with a mixing nozzle, and an atomizer tip (Duoflo, Baxter). Upon expression of the syringes, a fine mist spray extruded from the atomizer tip. The spray was directed onto a glass petri dish and formed a thin film that gelled in 3 minutes (3 min cure).

### Example 32

This example describes formation of a material of the present invention in vivo. A rabbit was humanely scarified. The ventral midline was opened using surgical techniques to expose the abdominal viscera. The liver was partially exposed and isolated. A laceration (approx 2 cm in length) was made in the liver using a scalpel blade. A hydrogel material made according to Example 28 was liberally sprayed into the exposed liver margin and along the liver surface as the incised edges were manually approximated. The cured hydrogel material effectively sealed the laceration and prevented reseparation of the liver margins.

### Example 33

This example describes formation of a material of the present invention in vivo. A rabbit was humanely scarified. The thoracic cavity was completely opened using surgical techniques and both sides of a lung were exposed. Approximately one centimeter (1 cm) of the distal end of the middle lung lobe was excised, and the lung was then inflated to maximum size. A hydrogel material made according to Example 28 was liberally sprayed onto the lung defect while the lung was inflated. The cured hydrogel material effectively sealed the lung and prevented air leakage.

### Example 34

This example describes formation of a material of the present invention in vivo. A rabbit was humanely scarified. The ventral midline was opened using surgical techniques to expose the abdominal viscera. A kidney was exposed and transversely incised down to the pelvis. A hydrogel material made according to Example 28 was liberally sprayed into the kidney defect and along the kidney surface as the incised edges were manually approximated. The cured hydrogel material effectively sealed the laceration and prevented reseparation of the kidney margins.

### Example 35

This example describes formation of a material of the present invention in vivo. A rabbit was humanely scarified. The ventral midline was opened using surgical techniques to expose the abdominal viscera, and the stomach was isolated. An open mesh of polytetrafluoroethylene (PTFE) material, obtained from W.L. Gore & Associates, Inc., was liberally sprayed with a hydrogel material made according to Example 30 to form a composite material. After allowing a partial 2 minute cure, the composite material was applied to the stomach's greater curvature and allowed to finish curing for an additional two minutes (2 min). The cured composite material was adherent to the stomach.

### Example 36

This example describes formation of a material of the present invention in vivo. A rabbit was humanely scarified. The ventral midline was opened using surgical techniques to expose the abdominal viscera, and the stomach was isolated. A highly porous bioabsorbable non-woven web material made according to U.S. Patent Publication 2007/0027550, which is incorporated herein by reference, was liberally sprayed with a hydrogel material made according to Example 30 to form a composite material. After allowing a partial 2 minute cure, the composite material was applied to the stomach's greater curvature and allowed to finish curing for an additional two minutes (2 min). The cured composite material was adherent to the stomach.

### Example 37

This example describes formation of a material of the present invention in vivo. A domestic pig was anesthetized. The liver was surgically exposed and partially isolated. Four large lacerations (approx. 4-5 cm in length) were made in the liver with a scalpel blade, and the cut edges were further disrupted digitally to increase bleeding from the liver. A highly porous bioabsorbable non-woven web material made according to U.S. Patent Publication 2007/0027550, which is incorporated herein by reference, was packed into the wound. A hydrogel material made according to Example 27 was then liberally sprayed into the exposed liver margins and along the liver surface. The cured hydrogel effectively prevented the extrusion of the highly porous bioabsorbable non-woven web material from the wound while the highly porous bioabsorbable non-woven web material composite significantly reduced bleeding of the liver. Histological examination with hematoxylin/eosin staining demonstrated excellent adhesion of the cured hydrogel to the liver capsule and to superficial blood.

### Example 38

This example describes formation of a material of the present invention in vitro. 0.4 grams of polyethylene glycol succinimidyl succinate (molecular weight 3400; SunBio, Inc.), 63 mg of colistin sulfate (Sigma), and 76 mg of sodium tetraborate decahydrate (Sigma) were blended into a fine dry powder using a mortar and pestle. The powder was wetted with 1 ml of deionized water. The powder formed a viscous slurry almost immediately, a soft, tacky dough after 20 seconds (20 sec dough time), and a nonpliable, nontacky, material after 90 seconds (90 sec cure time). The hydrogel material was immersed in phosphate buffered saline and formed a firm cohesive hydrogel.

### Example 39

This example describes formation of a material of the present invention in vitro. 0.4 grams of polyethylene glycol succinimidyl carbonate (molecular weight 3400; Laysan, Inc.), 63 mg of colistin sulfate (Sigma), and 76 mg of sodium tetraborate decahydrate (Sigma) were blended into a fine dry powder using a mortar and pestle. The powder was wetted with 1 ml of deionized water. The powder formed a viscous slurry after 3 minutes, a soft tacky dough after 6 minutes (6 min dough time), and a nonpliable, nontacky, material after 9 minutes (9 min cure time). The hydrogel material was immersed in phosphate buffered saline and formed a firm cohesive hydrogel.

### Example 40

This example describes formation of a material of the present invention having anti-microbial properties. A hydrogel material made according to Example 29 was applied onto a polycarbonate membrane (Poretics, Osmonics). The hydrogel coated membrane was plated onto an agar culture of Pseudomonas aeruginosa. After twenty-four hours (24 hr) of incubation at thirty-seven degrees centigrade (37° C.), the hydrogel coated membrane displayed minimal bacterial growth on its surface and displayed a zone of inhibition.

1. A hydrogel material comprising:
at least one water-soluble polymer cross-linked with a water-soluble crosslinker; and
wherein the crosslinker is an organic molecule with one core cyclic structure, two or more linking groups attached to the core cyclic structure, and one or more functional groups attached to each linking group.

2. The hydrogel material of claim 1 wherein said water-soluble polymer is synthetic.

3. The hydrogel material of claim 1 wherein said cyclic crosslinker has a molecular weight less than 10,000 Daltons.

4. The hydrogel material of claim 1 wherein said cyclic crosslinker has a molecular weight less than 7,500 Daltons.

5. The hydrogel material of claim 1 wherein said cyclic crosslinker has a molecular weight less than 6,000 Daltons.

6. The hydrogel material of claim 1 wherein said cyclic crosslinker has a molecular weight less than 5,000 Daltons.

7. A hydrogel material comprising:
at least one synthetic water-soluble polymer cross-linked with a water-soluble crosslinker;
wherein the crosslinker is an organic molecule with one core cyclic structure, two or more linking groups attached to the core cyclic structure, and one or more functional groups attached to each linking group; and
wherein the crosslinker has a molecular weight of less than 10,000 Daltons.

8. The hydrogel material of claim 7 wherein said cyclic crosslinker has a molecular weight less than 7,500 Daltons.

9. The hydrogel material of claim 7 wherein said cyclic crosslinker has a molecular weight less than 6,000 Daltons.

10. The hydrogel material of claim 7 wherein said cyclic crosslinker has a molecular weight less than 5,000 Daltons.

11. A method of making a hydrogel material comprising:
providing at least one synthetic water-soluble polymer;
providing a crosslinker in the form of an organic molecule with a molecular weight less than 10,000 Daltons, wherein said organic molecule has one core cyclic structure, two or more linking groups attached to the core cyclic structure, and one or more functional groups attached to each linking group; and
admixing said at least one synthetic water-soluble polymer with said crosslinker.

12. The hydrogel material of claim 11 wherein said cyclic crosslinker has a molecular weight less than 7,500 Daltons.

13. The hydrogel material of claim 11 wherein said cyclic crosslinker has a molecular weight less than 6,000 Daltons.

14. The hydrogel material of claim 11 wherein said cyclic crosslinker has a molecular weight less than 5,000 Daltons.

15. A hydrogel material made according to the method of claim 11.

16. A hydrogel material made according to the method of claim 12.

17. A hydrogel material made according to the method of claim 13.

18. A hydrogel material made according to the method of claim 13.

19. A hydrogel material made by polycondensation polymerization of polynucleophilic-polyelectrophilic precursors to form a water-soluble polymer crosslinked with a water-soluble cyclic crosslinker, wherein the crosslinker is an organic molecule having a molecular weight less than 10,000 Daltons, one core cyclic structure, two or more linking groups attached to the core cyclic structure, and one or more functional groups attached to each linking group.

20. The hydrogel material of claim 19 wherein said water-soluble polymer is synthetic.

21. The hydrogel material of claim 19 wherein said water-soluble cyclic cross-linker is synthetic.
